(19) United States
(12) Patent Application Publication
(10) Pub. No.: US 2026/0228104 A1
(43) Pub. Date: Aug. 6, 2026

(54) APPLICATION RIGHTSIZING AND RESOURCE CONSOLIDATION FOR SERVER SYSTEMS

(71) Applicant: Hewlett Packard Enterprise Development LP, Spring, TX (US)

(72) Inventors: Gourav Rattihalli, Milpitas, CA (US); Philipp Raith, Wien (AT); Pedro Henrique Rocha Bruel, San Jose, CA (US); Dejan Spasoje Milojicic, Palo Alto, CA (US)

(21) Appl. No.: 19/047,049

(22) Filed: Feb. 6, 2025

(51) Int. Cl. G06F 11/34; G06F 9/50

(52) U.S. Cl. CPC G06F 11/3452; G06F 9/5088

(57) ABSTRACT

Systems, methods, and devices for rightsizing data center resources to applications and consolidating server nodes including receiving a definition of goals for rightsizing and consolidating one or more server nodes of a server system and receiving a specification of a trigger for optimization. In the optimization, finding one or more sets of application runtime configurations for the server system and performing a trend analysis on a first set of the one or more application runtime configurations. In response to the trend analysis, predicting performance with consolidation of the one or more server nodes based at least in part on the trend analysis and confirming that the predicted performance matches the goals to verify that the first set satisfies the goals. In response to the performance matching the goals, implementing, by one or more processing resources, the first set of the application runtime configurations in the server system.

### BACKGROUND

Modern data centers may be relatively large with heterogeneous and/or homogeneous architectures. Heterogeneous architectures may include applications and data center infrastructure in a mix of different applications, containers, different virtualization types of virtual machines (VMs), and/or the like.

### BRIEF DESCRIPTION OF THE DRAWINGS

Features, aspects, and advantages of the present disclosure will become better understood when the following detailed description is read with reference to the accompanying drawings in which like characters represent like parts throughout the drawings, wherein:

FIG. 1 is a block diagram illustrating a server system with a configuration manager running on one or more server nodes to manage configurations of application runtimes and server configurations, in accordance with aspects of the present disclosure;

FIG. 2 is a block diagram illustrating a computing device that may implement the configuration manager of FIG. 1, in accordance with aspects of the present disclosure;

FIG. 3 is a flow diagram illustrating a process that a configuration manager may implement to rightsize resources allocated to applications in a server system and to consolidate server nodes of the server system, in accordance with aspects of the present disclosure;

FIG. 4 is a block diagram illustrating an architecture of a configuration manager with configuration repositories and trend data, in accordance with aspects of the present disclosure; and

FIG. 5 is a flow diagram illustrating an example process for implementing a migration of workload and optimizing application runtime configurations and data center configurations using a configuration manager, in accordance with aspects of the present disclosure.

### DETAILED DESCRIPTION

Heterogeneous architectures in data centers may include different server node configurations and/or different application configurations. Indeed, modern data centers are becoming more heterogeneous in structure and/or larger to accommodate heterogeneous applications, such as artificial intelligence (AI), high-performance computing (HPC), and general-purpose applications. Energy consumption and carbon emissions may be problematic limitations that may be targets for reduction. Due to elastic platform paradigms, applications may be started on demand at run-time to free resources otherwise. Moreover, users may specify resources that are to be allocated and are unusable by other applications. These two circumstances lead to resource inefficiency specifically including resource underutilization. Furthermore, difficulty in addressing resource inefficiency is exacerbated by heterogeneous implementations with different types of runtimes (e.g., different virtualization techniques) and/or hardware resources in a single system. However, if the resource inefficiency is not addressed quickly, the server system (e.g., system of more than 1 server, such as a data center or multiple data centers) may experience performance degradation and/or energy wastage.

To address resource inefficiency, data centers may adapt the pool of server nodes and rightsize applications to match applications to an appropriate amount of allocated resources. Adapting the pool and rightsizing the applications may be performed proactively to tune requirements and power cycle servers ahead of time. Indeed, as previously noted, a delay in tuning or shutting down servers may lead to performance degradation and energy wastage. Thus, to avoid such issues, adaptations may be performed by predicting trends to facilitate this approach rather than waiting for such adaptations to become completely necessary.

In addressing the resource inefficiency potential, configuration managers (e.g., managing hardware and/or software) may consider the power and resource usage states of servers and the resource demands of applications. The configuration managers may use trend-based and/or user goal-driven optimization of the application runtime configurations and node consolidation to reduce energy consumption and resource inefficiencies during run-time. In other words, the configuration managers dynamically optimize the application requirements to improve resource efficiency while maintaining throughput) and power cycling servers. The configuration managers may also use digital twins to capture historical data and trends across regions. A digital twin includes intelligent monitoring tools that capture fine-grained historical data and provide trend forecasts for the object(s)/system(s) by using virtual model(s) of the object(s) or system(s) to reflect their physical counterpart(s) accurately. Using these digital twins, the configuration managers may move workloads between data centers and/or change or create server nodes. Furthermore, this data may be used at runtime and/or may be used proactively with planning to update current data centers or build new data centers to plan for hardware or software changes to data centers.

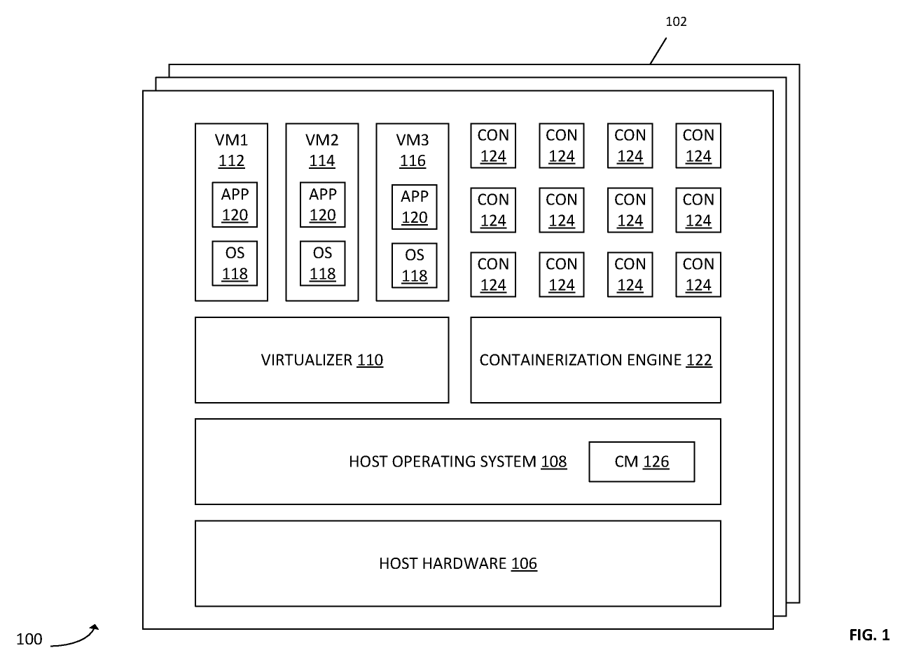

FIG. 1 is a block diagram illustrating an example server system 100 that has a heterogeneous architecture. The server system 100 may be located at a single geographic location, such as in a single data center in a single building, and/or may be distributed across multiple locations, such as one or more data centers in more than one building.

Each server 102 includes host hardware 106 that may include any physical hardware, such as a chassis, a memory, processing resource(s), interfaces, and the like used to implement a host operating system (OS) 108 on the host hardware 106. The OS 108 is software that supports basic computing functions, such as scheduling tasks, executing applications, and controlling peripherals. In general, the OS 108 manages the host hardware 106 and software resources while providing common services for applications running on the server(s) 102. The host hardware 106 may include bare metal nodes and/or virtual machines (VMs).

In the server system 100, the server 102 includes a virtualizer 110 that pools computing resources, such as memory, storage, and processing. The virtualizer 110 also enables the server 102 to enable multiple virtual machines to run on a single physical server. For instance, the virtualizer 110 enables a first virtual machine (VM1) 112, a second virtual machine (VM2) 114, and a third virtual machine (VM3) 116 to run on the server 102. Although three VMs are shown, the server 102 may implement any suitable number of VMs. Indeed, the number of VMs implemented by the server 102 may be dynamic over time by the host operating system 108 and/or one of its applications “spinning up” or shutting down VMs on demand.

VMs are a virtualization technique that bundle together multiple layers of software (i.e., from Kernel, OS to application) into a portable executable unit that can run any host that has the necessary drivers. VMs provide a strong isolation between the different VMs. As such, each virtual machine has its own operating system 118 and one or more applications 120 that run in the respective VM. As discussed herein, applications are source code/software instructions that may be executed by runtimes.

Runtimes may be resource isolation and/or virtualization structures/techniques that may include virtual machines (e.g., VM1, VM2, VM3), containers, MicroVMs, Unikernels, compiled application modules, and the like. Indeed, although the illustrated embodiment shows a combination of VMs and containers as runtimes implemented in the server 102, the server 102 may implement other runtime types, such as MicroVMs, Unikernels, compiled application modules, and/or other suitable available runtimes in addition or alternative to VMs and/or containers. MicroVMs include layers like a VM but have a purposefully reduced footprint. MicroVMs still provide strong isolation between execution units. In implementations of the server 102 with VMs or MicroVMs, the virtualizer 110 may be or may include a hypervisor or virtual machine manager (VMM).

Containers are a light-weight alternative to VMs. Containers, unlike VMs, include much smaller parts of a corresponding OS and the application. This means that containers are smaller in size and start faster than VMs. The containers share at least part of an OS kernel, such as a kernel of the OS 108 or of a VM if the containers are implemented in a VM, such as the VM1 112, VM2 114, and/or VM3 116. Containers use a containerization engine 122 to host containers in a docker, such as docker engine or Podman. The containerization engine 122 may be used to build and containerize applications into containers 124.

Unikernels package a small OS kernel and application into a portable executable that may run on bare metal of the host hardware 106 without hypervisors or other virtualizers 110. As such, Unikernels do not use intermediate layers, such as the containerization engine 122, used by containers. However, Unikernels have reduced functionality as their OS kernel does not include all features of the OS kernel of the OS 108 or another regular OS kernel. For example, Unikernel kernels may be limited to a single process without process forking.

A compiled application module may include binary instruction formatting (e.g., WebAssembly) for runtimes to implement a stack-based virtual machine. As such, the compiled application module-based runtimes offer fast speed up and portability for modules since such modules may run on any runtime. However, runtimes interface directly to the host and offer resource isolation without virtualization.

As noted above, each of the different available runtimes may have different advantages and disadvantages. This means that the server 102 may have a different optimum runtime for different situations and may provide any number of different runtimes for the correct situation. This variety of choice may exacerbate the challenge in a configuration manager (CM) 126 choosing the right configuration for running an application based on goals for the application and/or the server system 100. Although the CM 126 is shown in the OS 108 of single server 102, in some implementations, the CM 126 may be at least partially implemented outside of the server 102 and/or may be implemented in multiple servers 102. For instance, the CM 126 may be run remote to the server 102 and implement its changes to server nodes using a baseboard management controller (BMC).

In modern data centers, applications share their host with others (e.g., multi-tenancy) meaning that isolation may be an eminent concern in some implementations of the server system 100. As such, resource allocation by the CM 126 may also be a focus to manage processing resources of the host hardware 106, memory of the host hardware 106, storage of the host hardware 106, network bandwidth, and/or any other resources that an application may use in performing its corresponding function. For instance, processing resources may include processors (e.g., CPUs, GPUs, FPGAs, PLDs, etc.), hardware accelerators, or any other component that may execute source code. Resource allocation guarantees that applications may have exclusive rights to particular resources without having to share those resources. As discussed herein, the specification of the runtime and its corresponding resource allocations for an application are an application runtime configuration. For instance, if the source code is packaged in a container, the application runtime configuration may include a container configuration that is the configuration of the container in which the application is to be packaged. The application runtime configuration also includes a resource configuration that indicates an amount and/or location of resources being allocated to the application runtime.

The CM 126 may choose between configurations that include node configurations that configure the bare metal nodes and/or VMs. Each node configuration may include multiple nodes deployed in one or more data centers. Using these configurations and nodes, the CM 126 may control which applications have which resources. For instance, the CM 126 may have a bare metal configuration (BM1) that includes a set number (e.g., 256) of CPU cores, a set amount (e.g., 256 GB) of memory, a number (e.g., 2) of GPUs, and/or other components, such as network interface controllers, FPGAs, PLDs, etc. Each node of BM1 would offer respective resources to applications allocated to the respective BM1. Furthermore, the CM 126 may also manage nodes that are VMs and/or include VMs.

The CM 126 and/or the OS 108 may manage a power state of the nodes. Different node types may have different available power states. For instance, VM nodes may have an idle state, a hibernate state, a running state, a shutdown state, and a removed state. Physical machines/bare metal nodes may have an idle state, a hibernate state, a running state, a shutdown state, a suspend-to-CPU state, a suspend-to-memory state, and a suspend-to-disk state. Furthermore, the amount of time to power cycle nodes may change depending on the node type. The CM 126 and/or the OS 108 may take the differences and different states into account and use them in deploying application runtime configurations in the server system 100.

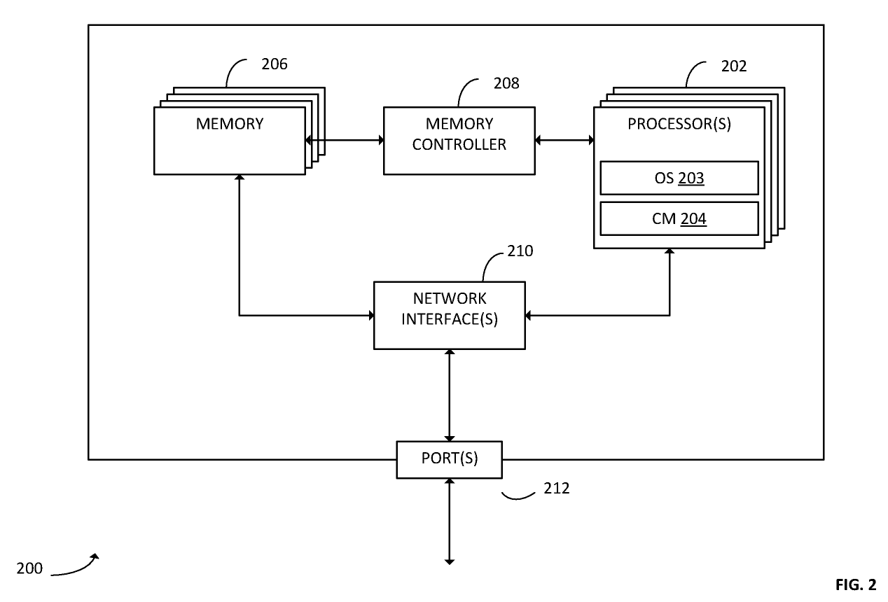

FIG. 2 is a block diagram of a computing system 200. For instance, the computing system 200 may be a server implemented using host hardware, such as the host hardware 106. The computing system 200 has one or more processors 202. The one or more processors 202 may include one or more processing resources, such as a central processing unit (CPU), a graphics processing unit (GPU), implemented using a field programmable gate array (FPGA), hardware accelerators, or a combination thereof. Functionalities described herein may be implemented via hardware (e.g., electronic circuitry) or a combination of hardware and programming (the combination comprising, e.g., at least one processor and instructions executable by the at least one processor and stored on at least one machine-readable storage medium). For example, the one or more processors 202 may execute various stored instructions, such as instructions executable to implement an operating system (OS) 203 (e.g., OS 108) and a configuration manager (CM) 204. The CM 204 may manage configuration of nodes of the host hardware and/or software and may function similarly to the operations discussed above in reference to the CM 126.

The programs described herein may be implemented by instructions executed by the one or more processors 202 and may be stored in any suitable article of manufacture that includes one or more non-transitory and computer-readable storage media at least collectively storing the instructions or routines. For instance, the instructions may be stored in a memory 206 of the computing system 200. The memory 206 may include any suitable articles of manufacture suitable for storing data and/or executable instructions that may be executed by the one or more processors 202. The memory 206 may include any suitable memory devices, such as random-access memory (RAM), including but not limited to, double data rate type 5 (DDR5) synchronous dynamic random-access memory (SDRAM), double data rate type 4 (DDR4) SDRAM, low-power double data rate (LPDDR) SDRAM, another suitable type of memory device, or any combination thereof. The memory 206 may include one or more different memory devices. Additionally or alternatively, the memory 206 may include a storage device, such as a Non-Volatile Memory Express (NVMe) device, a hard disk drive (HDD), a solid-state drive (SSD), an optical drive, another type of storage device, flash memory, read-only memory (ROM), or any combination thereof.

To facilitate control of the memory 206 and/or exchange of data between the one or more processors 202 and the memory 206, the computing system 200 includes a memory controller 208. The memory controller 208 may be a hardware and/or software component that connects one or more diverse types of memory in the memory 206 to the one or more processors 202 (e.g., via a processor bus of the one or more processors 202). The memory controller 208 may be part of the one or more processors 202 and/or may be implemented on a separate chip mounted on a baseboard of the computing system 200. The memory controller 208 manages data flow between the memory 206 and the one or more processors 202 including memory read and write operations. During a power up of the computing system 200, the memory controller 208 configures and enables use of specific memory devices of the memory 206. Additionally, the memory controller 208 may manage various functions, such as error correction, memory refresh operations, and power management of the memory 206.

The computing system 200 may further include one or more network interfaces 210 that may be implemented by one or more network interface controllers. A network interface controller may be a hardware component or combination of hardware (e.g., processor(s)) and instructions executable by the hardware and that connects the computing system 200 to one or more networks. The network interface(s) 210 provide a connection for the computing system 200 to the network through one or more ports 212.

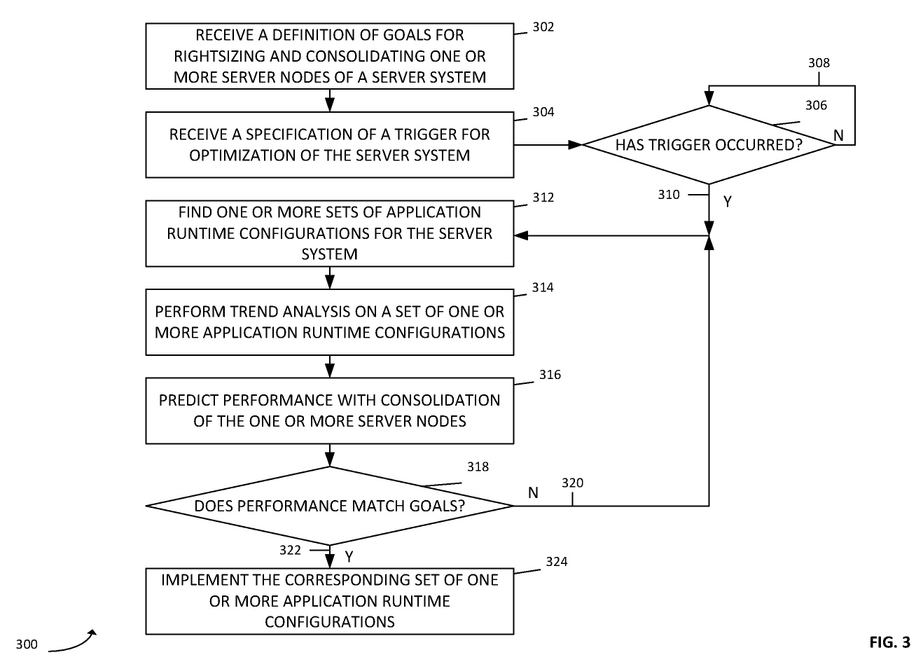

FIG. 3 is a flow diagram of a process 300 for rightsizing application configurations and consolidating server nodes of a server system. For instance, the process 300 may be implemented by a configuration manager (e.g., the CM 126 and/or the CM 204). The configuration manager may be implemented using instructions stored in memory that are executed by one or more processing resources, such as a CPU, a GPU, a programmable logic device, and/or a combination thereof.

As previously noted, application runtime configurations may suffer from low resource efficiency. Resource efficiency is the ratio between used resources and allocated resources. For instance, an application may be allocated CPU core but may only use half of the core leading to a 50% resource efficiency. The configuration manager uses the process 300 to enhance or even optimize the resource efficiency while maintaining performance guarantees. The configuration manager also may use the process 300 to consolidate server resources by migrating applications onto a reduced set of server nodes (e.g., VMs and/or bare metal nodes) to save energy consumption by the server system.

As part of the process 300, the configuration manager receives a definition of goals for rightsizing and consolidating one or more server nodes of a server system (block 302). For instance, the server system 100 may be an example server system that may be rightsized and consolidated among servers 102 using the configuration manager (e.g., CM 126). The goals may be user-defined received from a user/customer and/or may be based on local rules or regulations for data centers of the server system 100. Additionally or alternatively, the goals may be defined in a customer agreement with the customer. For instance, the goals may include guarantees of a minimum amount of resources to be available for a customer’s application.

The goals may be based on use cases, such as a goal to use all resources, costs, workload, temperature limits, cooling costs, reach application performance targets, prioritize certain heterogeneous node configurations, keep a maximum power consumption below a maximum power consumption threshold, keep a startup power consumption below a startup power consumption threshold, keep an idle power consumption below an idle power consumption threshold, reach a target shutdown duration, reach a target turn-on duration, maintain carbon emissions targets (e.g., 50%, 60%, 70%, etc. of regulated limits), and the like. As such, the goals may be absolute values and/or may be percentages of hard limits (e.g., emissions regulations numbers, power consumption numbers, etc.).

In some implementations, one or more goals may be combined into a combined/overall goal between different goal types (e.g., performance v. power) and/or different physical/virtual machines. Indeed, power consumption may be heterogeneous between nodes, and the configuration manager may use goals that may take advantage of such heterogeneity.

The configuration manager also receives a specification of a trigger for optimization of the server system (block 304). The specification of the trigger may indicate when the system is to be optimized. The trigger may be event-based and/or may be time-based. For an event-based trigger, the event that triggers the optimizations calculation may correspond to any of the metrics of the goals (e.g., emissions, power, efficiency, etc.) crossing respective thresholds. For instance, the trigger may be event-based when the resource efficiency of one or more applications and/or of the whole system falling below a resource efficiency threshold (e.g., 20%, 30%, etc.). The thresholds may differ for specific resources and/or may be different for individual resources and may include an overall threshold for the entire system. These thresholds for the optimization may be the same as the goals and/or may be based on a relationship of the goals. For instance, if a metric (e.g., emissions or power) is relatively close to a respective threshold (e.g., 80%-90% of the threshold). Additionally or alternatively, the thresholds for optimization may be user specified, specified in a contract, based on data center rules, based on local regulations where data center(s) are located, or a combination thereof.

A time-based trigger may cause periodic optimization calculations regardless of whether a qualifying event has occurred. Instead, the time-based trigger uses a counter to invoke optimization calculations ensuring that optimization calculations occur no less frequent than a specified time. This time-based triggering may prevent stale configurations from being used overly long while technically inside of set thresholds but still be sub-optimum. The duration of time between optimization calculations maybe set by user definitions, system settings, and/or any other mechanism for defining how frequently to perform optimization calculations. In some implementations, the counter may be reset whenever an optimization calculation is performed whether it is triggered by a time-based trigger or an event-based trigger. Additionally or alternatively, the counter may be independent of event-based optimization calculations and reset only when a time-based optimization occurs.

The configuration manager then checks whether the trigger has occurred (block 306). If no trigger has occurred (e.g., the timer has not elapsed and no event has occurred), the configuration manager waits (308) and continues checking for whether a trigger has occurred. However, once a trigger has occurred (310), the configuration manager performs an optimization calculation to increase optimization of the server system. As previously noted, increasing optimization includes increasing resource efficiency while also consolidating server nodes.

As a first step of the optimization calculation, the configuration manager finds one or more sets of application runtime configurations for the server system (block 312). The configuration manager searches for application configuration runtime sets in an application configuration runtime repository in storage of the server system. This search may be performed during and/or before runtime. These application runtime configurations may include data center configurations and their respective node configurations, virtualization configurations (e.g., types and settings), and any other configurations that may impact performance and/or resource usage of the server system. These different configurations may be indexed by different goals. For instance, if the current settings are indexed to a goal that has been violated by a trigger, the configuration manager may choose a next (e.g., next lower power, next lower emissions, etc.) configuration set in the one or more sets of application runtime configurations.

The configuration manager then performs a trend analysis using trend data of the application, the local data center where the application is to be implemented, the server system, or a combination thereof to determine an amount of resources that can satisfy the demands (block 314). The determination of this amount of resources enables the sizing of allocated resources to the resource demands or rightsizing the allocated resources to the resource demands. The rightsizing of resources may include adding or removing resources from the resource configuration of an application runtime configuration.

The trend data is a collection of forecasts for different aspects of a data center. For instance, the trend data may include estimated/predicted trends based on historical data related to carbon emissions, workload, temperature, costs, cooling, and/or any other data related to the goals.

Using the trend data, the configuration manager may predict future demands on resources of the data center from the application(s) both in workloads and other impacts, such as emissions, power consumption, costs, and/or the like. Using this predicted demands, the configuration manager may predict performance using the trend analysis with consolidation of one or more server nodes (block 316). As used herein, consolidation of nodes may include adding or removing server nodes (e.g., software or hardware) by power cycling and/or removing such nodes. Additionally or alternatively, the consolidation of nodes may include changing a power state of at least one of the server nodes. For instance, the changing of a power state may include changing the state from a running state to an idle state, changing an idle state to a shutdown state or a removed state, or the like for at least one of the server nodes.

This predicted performance may include matching planned allocations of resources to the predicted application demands from the trend data. In some implementations, this prediction may include simulation of application functions using resources to verify the suitability of the consolidated and rightsized resources.

In some implementations, the configuration manager may perform rightsizing of resources to match allocations to resource demands and consolidation of server nodes at different times (e.g., consecutively) or may perform them at least partially simultaneously that overlaps in time by some amount. Once both are computed, the configuration manager determines whether the predicted performance matches the defined goals (block 318). For instance, the configuration manager may determine whether simulated results of the rightsizing and consolidation still meet the defined goals.

If the predicted performance does not match the defined goals (320), the configuration manager may find one or more other sets of application runtime configurations and perform optimization calculations on those other sets of application runtime configurations to attempt to find another solution that rightsizes and consolidates nodes in a more suitable manner. However, if the predicted performance matches the goals (322), the configuration manager implements the corresponding set of one or more application runtime configurations (block 324). For instance, the configuration manager may migrate a workload between server nodes, shutdown at least one server node, and change configuration allocation of one or more resources to an application. These changes may be made to physical and/or virtual server nodes. In other words, after confirming that predicted operation using planned configurations matches goals, the configuration manager then implements such planned configurations in actual production.

In some implementations where the configuration manager is used for planning future changes to a data center, implementing the corresponding set may include making a suggestion, starting an order for new/updated hardware, providing feedback on a planned update to hardware of a data center, providing feedback on a planned new data center, and/or any other steps to move implementation forward by deploying new/updated hardware to a data center. In such situations, the configuration manager may be used to confirm that planned changes may be suitable for expected application demand and suitable for a specific implementation.

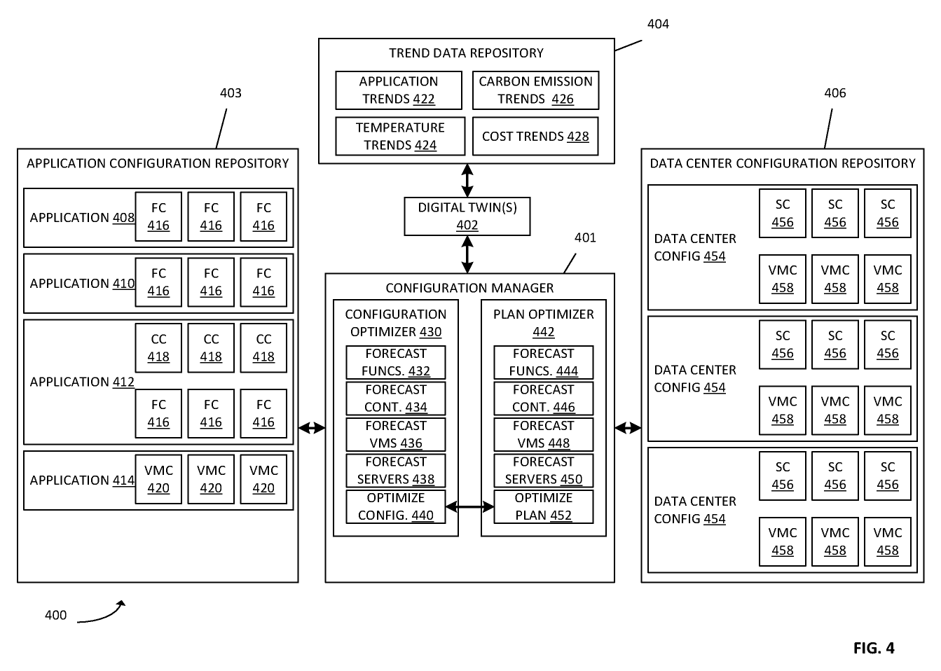

FIG. 4 is a block diagram of an architecture 400 of a configuration manager 401, such as the CM 126 or the CM 204. As illustrated, the configuration manager 401 uses one or more digital twin(s) 402 of server resources of a server system across multiple geographic locations. In other words, the server system may include multiple data centers in different locations, cities, states, or even countries. Digital twins are intelligent monitoring tools and models that capture historical data and trends across regions (e.g., in different data centers across the regions).

The configuration manager 401 also utilizes an application configuration repository 403 that stores available application configuration runtime sets. This application configuration repository 403 may be located in storage (e.g., memory 206) of one or more computing systems of the server system. For instance, the application configuration repository 403 may be a server database made available for managing storage resources.

The application configuration repository 403 may store available application runtime configurations for applications of the server system. For instance, the illustrated implementation of the application configuration repository 403 includes four applications: application 408, application 410, application 412, and application 414. Although the illustrated example includes four applications, any suitable number of applications may be stored in the application configuration repository 403.

As previously noted, application runtime configurations may include any configuration information that may be used to implement or change resources available to the applications. For example, the application runtime configurations for the application 408, the application 410, and the application 412 may include multiple available function configurations (FC) 416. The FCs 416 each define specific parameters and settings of a function within the software of the respective applications. Each different FC 416 may define different settings that may have different impacts on whether goals are achieved. Furthermore, the FCs 416 may include resource configurations that have settings for resources that may be allocated to the respective application.

In addition to or alternative to function configurations, the application runtime configurations may include available configurations for other aspects, such as available container configurations (CC) 418 or available VM configurations (VMCs) 420. The CCs 418 contain information for creating and/or configuring containers for implementing respective applications. For instance, the application runtime configuration of the application 412 may have CCs 418 that have sets of settings for containers that implement the application 412. Likewise, the VMCs 420 contain information for creating and/or configuring VMs for implementing respective applications. For instance, the application runtime configuration for the application 414 may have sets of VMCs 420 that are used to create and/or configure VMs that implement the application 414.

Furthermore, the application configuration repository 403 may store other configurations for other virtualization types that may be used to implement an application. For instance, the application runtime configurations may include available configurations for MicroVMs, Unikernels, compiled application modules, or any other runtime types. Furthermore, at least some application runtime configurations of some applications may have multiple virtualization types available. For instance, an application runtime configuration for a single application may include both CCs 418 and VMCs 420 that enables the configuration manager 401 to switch between containers and VMs.

The configuration manager 401 uses trend data stored in a trend data repository 404. The trend data repository 404 may be stored in a same location (e.g., a database) as the application configuration repository 403 and/or may be stored in a different location (e.g., in the memory 206) that is accessible by the configuration manager 401. The trend data repository 404 may store any trend data of trends that may be applicable to estimate future usage of the server system, a server, and/or a data center of the server system.

The trend data repository 404 may store application trends 422 that indicate previous usage of applications including power consumption, processing demands, throughput, bandwidth consumed, resource efficiency, and/or other key performance indicators. The trend data may be periodic or cyclical and indicate patterns of usage, such as higher demand during certain hours (e.g., 9 AM to 5 PM) for certain applications. Furthermore, the trends (and/or the digital twin(s) 402) may plot past data and the trends in the data to identify an expected usage (e.g., demand) in the future.

Similarly, the trend data repository 404 may store trends for any other data that may be tracked. For instance, trends may be kept for any parameter that may be related to at least one defined goal for the server system. The trend data repository 404 may store temperature trends 424 that store past temperatures and/or amount of cooling used in the data center to maintain stable operating temperatures. The trend data may correlate temperature changes to other factors, such as ambient temperature, application demands, and/or other factors. Furthermore, in predicting future temperature using trend data, the configuration manager 401 and/or the digital twin(s) 402 may include forecasted weather conditions for data centers.

The trend data repository 404 may also store carbon emission trends 426. The carbon emission trends 426 may track estimated emissions based on power consumption, power generation emissions regulations and/or rates, regional weather conditions, and/or other information that impacts carbon emissions. The configuration manager 401 and/or the digital twin(s) 402 then use this information along with expected demand to forecast carbon emissions in the future.

The trend data repository 404 also may store cost trends 428 that track costs for implementation. The costs trends 428 may include customer costs for specific applications, costs for power consumption for a data center/server, costs for cooling a data center/server, and the like. The costs trends 428, the configuration manager 401, and/or the digital twin(s) 402 may estimate future costs by which application runtime configurations are being implemented and based on future estimated demand.

The configuration manager 401 may use any of the trend data from the trend data repository 404 and/or the digital twin(s) 402 to forecast operation of the server system by estimating demand and other factors. The configuration manager 401 then uses these values to choose which application runtime configurations to implement from the application configuration repository 403 using a configuration optimizer logic 430. For instance, the configuration optimizer logic 430 may include forecasting functions logic 432 that forecasts active functions and any data from the trends or discussed in relation to goals based on selected FCs 416. The configuration optimizer logic 430 may also include forecasting containers logic 434 that forecasts active containers and any data from the trends or discussed in relation to goals based on selected CCs 418. Likewise, the configuration optimizer logic 430 may also include forecasting VM logic 436 that forecasts active VMs and any data from the trends or discussed in relation to goals based on selected VMCs 420. The configuration optimizer logic 430 may also include logic to predict active other virtualizations, such as MicroVMs, Unikernels, compiled application modules, and the like.

The configuration optimizer logic 430 further includes optimizer configuration logic 440 that at least partially optimizes the selection of sets of runtime configurations from the application configuration repository based on the forecasted functions, containers, VMs, servers by determining the impact of the selected configurations to rightsize allocation of applications to resources and to consolidate server nodes for power consumption efficiency. For example, the configuration manager 401 may use the techniques discussed above in relation to FIG. 3.

In some implementations, the configuration manager 401 may tune data center configurations using the digital twin(s) 402 of the servers and/or data centers and available data center/server configurations stored in a data center configuration repository 406. For instance, the configuration manager 401 may change or create server nodes in addition to or alternative to removing nodes.

The data center configuration repository 406 may store available data center configurations for different data centers. For instance, the data center configuration repository 406 may include a data center configuration 454 for each separate data center. The data center configuration repository 406 includes available configurations for each of three data centers, but similar techniques may be applicable to any number of data centers.

For each data center configuration, the data center configuration repository 406 stores available server configurations (SC) 456 for each data center. For instance, the data centers may be in different locations. Although the illustrated implementation includes three available data server configurations for each data center configuration, the number of available SCs 456 may differ by server, by data center, or regions. Furthermore, each data center may deploy different configurations on different servers of the data center in a heterogeneous composition. The SCs 456 may include which workloads are deployed at which data centers enabling such considerations to be factored into workload migrations between data centers and/or geographic regions. The SCs 456 may enable the configuration manager to change runtimes (e.g., VMs to containers) implemented as the server nodes making more levels available for rightsizing. In other words, the SCs 456 add multi-level policies on top of the levels of configuration available for each application and node. As part of these changes, the configuration manager 401 may use VMCs 458 to spin up new VMs and/or modify existing VMs.

As previously noted, the configuration manager 401 may use any of the trend data from the trend data repository 404 and/or the digital twin(s) 402 to forecast operation of the server system by estimating demand and other factors. The configuration manager 401 then uses these values to choose which data center configurations (and respective SCs 456) to implement from the data center configuration repository 406 using a plan optimizer logic 442. For instance, the plan optimizer logic 442 may include forecasting functions logic 444 that forecasts active functions and any data from the trends or discussed in relation to goals based on selected FCs 416. The plan optimizer logic 442 may also include forecasting containers logic 446 that forecasts active containers and any data from the trends or discussed in relation to goals based on selected CCs 418. Likewise, the plan optimizer logic 442 may also include forecasting VM logic 448 that forecasts active VMs and any data from the trends or discussed in relation to goals based on selected VMCs 420. The plan optimizer logic 442 may also include logic to predict active other virtualizations, such as MicroVMs, Unikernels, compiled application modules, and the like.

The plan optimizer logic 442 further includes optimizer plan logic 452 that at least partially optimizes the selection of sets of server configurations from the data center configuration repository 406 based on the forecasted functions, containers, VMs, servers, and data centers in an optimized plan that meets goals more closely than a previous implementation. For instance, the plan may include moving workloads between regions based on temperature, carbon emissions limits or regulations, available bandwidth, or any other characteristic of the data centers. Additionally or alternatively, the plan may include switching implementation types, such as switching from VMs to containers. Furthermore, the plan may include adding new server nodes, such as VMs, containers, and/or the like. For instance, the plan may include adding more server nodes in response to the inability to satisfactorily meet demand with current server nodes, in response to a determination that another server node is to be shut down, in response to a workload migration between data centers, and/or in response to any other determination that may demand a new or different type of server node that is not currently available.

As may be appreciated, the optimization of the data centers and of the application runtimes may depend on selections from each other. As such, the configuration optimizer logic 430 and the plan optimizer logic 442 may communicate such predicted outcomes and selections between each other. For instance, the plan optimizer logic 442 may notify the configuration optimizer logic 430 when one or more server nodes are created or changed in a way that may impact selection of the corresponding application runtime configurations. In response to such communications, the configuration optimizer logic may reselect between the available application runtime configurations based on the changes and recompute the predicted results. Thus, the optimization of the configurations and plan may be iterative and/or may occur at least partially simultaneously.

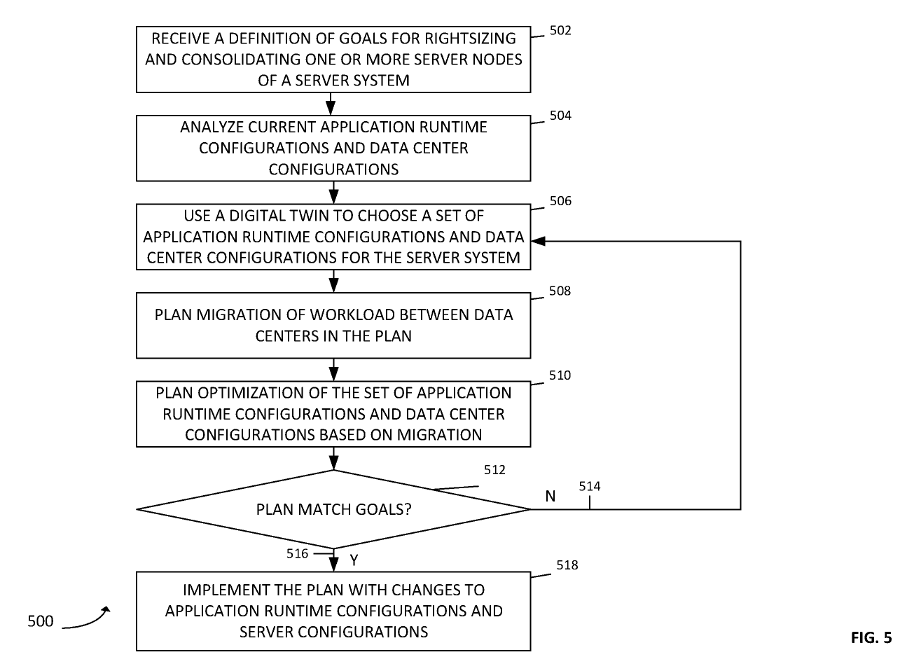

FIG. 5 is a flow diagram of a process 500 that includes optimizing server configurations and application runtime configurations in a plan. For instance, the process 500 may be implemented by a configuration manager (e.g., the CM 126, the CM 204, and/or the configuration manager 401). The configuration manager may be implemented using instructions stored in memory that are executed by one or more processing resources, such as a CPU, a GPU, a programmable logic device, and/or a combination thereof.

As part of the process 500, the configuration manager receives a definition of goals for rightsizing and consolidating one or more server nodes of a server system (block 502). For instance, the server system 100 may be an example server system that may be rightsized and consolidated among servers 102 using the configuration manager 126. The goals may be user-defined received from a user/customer and/or may be based on local rules or regulations for data centers of the server system 100. Additionally or alternatively, the goals (e.g., cost or performance based) may be defined in a customer agreement with the customer. For instance, the goals may include guarantees of a minimum amount of resources to be available for a customer’s application.

The goals may be based on use cases, such as a goal to use all resources, reach application performance targets, costs, workload, temperature limits, cooling costs, prioritize certain heterogeneous node configurations, keep a maximum power consumption below a maximum power consumption threshold, keep a startup power consumption below a startup power consumption threshold, keep an idle power consumption below an idle power consumption threshold, reach a target shutdown duration, reach a target turn-on duration, maintain carbon emissions targets (e.g., 50%, 60%, 70%, etc. of regulated limits), and the like. As such, the goals may be absolute values and/or may be percentages of hard limits (e.g., emissions regulations numbers, power consumption numbers, etc.).

In some implementations, one or more goals may be combined into a combined/overall goal between different goal types (e.g., performance v. power) and/or different physical/virtual machines. Indeed, power consumption may be heterogeneous between nodes, and the configuration manager may use goals that may take advantage of such heterogeneity.

The configuration manager then analyzes the current application runtime configurations and data center configurations (block 504). For instance, the configuration manager may determine existence of resource inefficiencies that may be addressed by rightsizing and resource consolidation. The configuration manager may identify potentially problematic issues, such as carbon emissions of a data center approaching region-based emissions limits or that at least one goal may be close to being unmet or is predicted to be unmet using current configurations and current trends. In some implementations, there may be no current application runtime configurations or data center configurations if the configuration manager is used to plan a new data center. In such situations, the configuration manager may analyze similar data centers and change parameters (e.g., in a digital twin) based on specifics to the planned data center (e.g., geographic location, etc.).

In response to the current application analysis, the configuration manager uses a digital twin (e.g., digital twin(s) 402) to choose a set of application runtime configurations and data center configurations for the server system (block 506). As previously noted, the digital twin may track detailed information regarding data centers and/or their servers along with specific information, such as geographic region, weather forecasts, emissions rates, and the like. The digital twin may model the real-world servers and/or data centers that it tracks.

The digital twin may include trend data of the data center, its server, and/or the server system that includes multiple data centers. The configuration manager uses the trend data to determine resource demands. The determination of this amount of resources enables the sizing of allocated resources to the resource demands or rightsizing the allocated resources to the resource demands. The rightsizing of resources may include adding or removing resources from the resource configuration of an application runtime configuration.

The trend data is a collection of forecasts for different aspects of a data center. For instance, the trend data may include estimated/predicted trends based on historical data related to carbon emissions, workload, temperature, costs, cooling, and/or any other data related to the goals.

Using the trend data, the configuration manager may predict future demands on resources of the data center from the application(s) both in workloads and other impacts, such as emissions, power consumption, costs, and/or the like. Using this predicted demands and the selected application runtime configurations, the configuration manager may plan to migrate at least some workload between data centers in a plan for the server system (block 508). For instance, the configuration manager may determine that more efficient operation may be achieved by moving the at least some workload between data centers. Additionally or alternatively, the configuration manager, using the digital twin, may use emissions rates to determine to shift at least some workload to another geographic region. For instance, emissions limits may be tighter in some regions with tighter meaning that the emissions rates are more restricted or are closer to the current operation. Additional or alternatively, the configuration manager, using the digital twin, may determine that weather, such as extreme heat, a hurricane, an electrical storm, or other weather conditions that may impact performance are predicted for at least one region. The configuration manager may shift at least some workload to at least partially alleviate such concerns. Moreover, the configuration manager may move the workload based on user inputs, a planned maintenance to at least a portion of a data center, data privacy laws/regulations, and/or any other reason that the workload may be migrated between data centers.

The configuration manager also plans optimization of the set of application runtime configurations and data center configurations based on the migration in the plan (block 510). As used herein, the optimization may include adding, removing, or changing server nodes (e.g., software or hardware) by power cycling and/or removing such nodes. Additionally or alternatively, the optimization may include changing a power state of at least one of the server nodes. For instance, the changing of a power state may include changing a state from a running state to an idle state, changing an idle state to a shutdown state or a removed state, or the like for at least one of the server nodes.

In situations where the configuration manager is used to plan for a new data center or a refresh of a current data center, the changes may be prospective changes/implementations. For instance, the results may be used as a design for an initial data center or a re-design/refresh of a current data center including compute infrastructure and application changes. Different use cases, such as AI, general purpose, high-performance computing, and the like, may be considered beforehand and evaluated before implementation. In such situations, the outcome of the configuration manager may include insights. These insights may include a recommendation along with a report of various predicted levels of the various goals (e.g., a comparison with and without hardware changes), such as costs, emissions (e.g., time to carbon neutral estimates), power consumption, resource efficiency, and the like. This estimation may be realistic even for new data centers using digital twins in a hypothetical scenario to provide information about existing infrastructures and to test new node configurations and/or applications. The configuration manager may use multiple performance indicators and may weight them to give a composite score to particular configurations and/or select a most suitable option from the composite score. The weighting of the factors may be different for different locations and/or data center plans.

Since the plan includes migration and rightsizing/modification before actual implementation, they are executed in tandem where data center configurations and application runtime configurations are computed with workload migration. Tandem computation intimates that the aspects of rightsizing and workload migration are considered together in one combined computation. This tandem computation makes optimization of the system faster and more thorough even in heterogeneous systems. In other words, the plan may be implemented without multiple power cycles and state changes to fine tune data center operations.

The configuration manager then checks whether the plan matches goals (block 512). For instance, the configuration manager may simulate results using the digital twin and determine whether simulated results of the rightsizing and consolidation and workload migration meet the defined goals. In some embodiments the configuration manager may check combinations of multiple different configuration sets and choose only one as matching the goals. In other words, in some implementations, the goals may be set to find the most optimum configuration from the available configurations.

If the plan does not match the defined goals (514), the configuration manager rejects the plan and may find one or more other sets of application runtime configurations, server configurations, and/or planned migrations to attempt to find another solution that rightsizes and consolidates nodes in a more suitable manner. However, if the plan matches the goals (516), the configuration manager implements the plan with changes to application runtime configurations and server configurations to implement the workload migration (block 518). For instance, the configuration manager may migrate a workload between server nodes, shutdown at least one server node, and change configuration allocation of one or more resources to an application. These changes may be made to physical and/or virtual server nodes. In other words, after confirming that the plan matches goals using planned configurations, the configuration manager then implements such planned configurations in actual production.

In some implementations where the configuration manager is used for planning future hardware changes to a data center, implementing the corresponding set may include making a suggestion, starting an order for new/updated hardware, providing simulation results, providing an indication of whether the simulated results meet the goals, providing feedback on a planned update to hardware of a data center including simulation results based on existing data centers and expected usage, providing feedback on a planned new data center including simulation results based on existing data centers and expected usage, and/or any other steps to move implementation forward by deploying new/updated hardware to a data center. In such situations, the configuration manager may be used to confirm that planned changes may be suitable for expected application demand and suitable for a specific deployment.

One or more specific aspects of the present disclosure are described above. In an effort to provide a concise description of these aspects, all features of an actual implementation may not be described in the specification. It should be appreciated that in the development of any such actual implementation, as in any engineering or design project, numerous implementation-specific decisions are made to achieve the developers’ specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various aspects of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

While certain features of the present disclosure have been illustrated and described herein, many modifications and changes will occur to those skilled in the art. It is, therefore, to be understood that the appended claims are intended to cover all such modifications and changes as fall within the true spirit of the present disclosure.

1. A method, comprising:
receiving, at one or more processing resources, a definition of goals for rightsizing and consolidating one or more server nodes of a server system;
receiving, at the one or more processing resources, a specification of a trigger for optimization of the server system;
finding, by the one or more processing resources, one or more sets of application runtime configurations for the server system;
performing, by the one or more processing resources, a trend analysis on a first set of the one or more sets of application runtime configurations;
predicting, by the one or more processing resources, performance with consolidation of the one or more server nodes based at least in part on the trend analysis;
confirming, by the one or more processing resources, that the predicted performance matches the goals to verify that the first set satisfies the goals; and
in response to the predicted performance matching the goals, implementing, by the one or more processing resources, the first set of the one or more sets of application runtime configurations in the server system.

2. The method of claim 1, wherein finding the one or more sets comprises using a digital twin of the server system.

3. The method of claim 1, comprising:
predicting, by the one or more processing resources, performance with a data center optimization change for the first set; and
in response to the predicted performance matching the goals, implementing, by the one or more processing resources, the data center optimization.

4. The method of claim 3, wherein the data center optimization change comprises changing runtime types of one of the one or server nodes or creating a new server node of the server system.

5. The method of claim 1, wherein the consolidation of the one or more server nodes comprises migrating a workload between data centers in different geographical regions.

6. The method of claim 5, comprising:
determining, by the one or more processing resources, that a first region of the different geographical regions has tighter emission rate restrictions than a second region of the different geographical regions, wherein migrating the workload between data centers in the different geographical regions comprises migrating the workload from the first region to the second region.

7. The method of claim 1, wherein implementing the first set of the one or more sets of application runtime configurations comprises evaluating potential hardware changes to the server system as part of the implementation and providing insights relative to the hardware changes.

8. The method of claim 7, wherein the insights comprise estimated resource efficiency after the hardware changes, application performance after the hardware changes, and carbon emissions insights after the hardware changes.

9. The method of claim 8, wherein the carbon emissions insights comprise a time to carbon neutral, dynamic emissions at runtime, and a comparison to carbon emissions without the hardware changes.

10. The method of claim 8, wherein the insights comprise a comparison to the estimated resource efficiency with and without the hardware changes and the application performance with and without the hardware changes.

11. The method of claim 1, wherein the goals comprise power consumption of a data center, heterogeneous node configurations of the data center, application performance of the data center, or shutdown or startup duration for the data center.

12. The method of claim 11, wherein the power consumption of the data center comprises a maximum power consumption of the data center, a start power consumption of the data center, or an idle power consumption of the data center.

13. The method of claim 1, wherein finding the one or more sets comprises for each different type of object in the server system, looking up a potential available configuration in a database and identifying different combinations of the available configurations of the different types of objects together as a set of the one or more sets, wherein the server system comprises a heterogeneous server system.

14. A non-transitory, computer-readable medium having instructions stored thereon that, when executed by one or more processing resources, are configured to cause the one or more processing resources to:
receive a definition of goals for rightsizing and consolidating one or more server nodes of a server system;
receive a specification of a trigger for optimization of the server system;
find one or more sets of application runtime configurations for the server system;
perform a trend analysis on a first set of the one or more sets of application runtime configurations;
predict performance with consolidation of the one or more server nodes based at least in part on the trend analysis;
confirm that the predicted performance matches the goals to verify that the first set satisfies the goals; and
in response to the predicted performance matching the goals, implement the first set of the one or more sets of application runtime configurations in the server system.

15. The non-transitory, computer-readable medium of claim 14, wherein finding the one or more sets of application runtime configurations comprises using a digital twin to simulate one or more metrics corresponding to the goals.

16. The non-transitory, computer-readable medium of claim 14, wherein the instructions are configured to cause the one or more processing resources to:
predict performance with a data center optimization change for the first set; and
in response to the predicted performance matching the goals, implement the data center optimization.

17. The non-transitory, computer-readable medium of claim 14, wherein the instructions are configured to cause the one or more processing resources to:
perform an additional trend analysis on a second set of the one or more sets of application runtime configurations before performing the trend analysis on the first set;
in response to the additional trend analysis, predict additional performance based on the additional trend analysis;
in response to the prediction of the additional performance, determine that the additional performance does not match the goals; and
in response to the determination that the additional performance does not match the goals, reject the second set before performing the trend analysis on the first set.

18. A system, comprising:
one or more processing resources; and
computer-readable medium storing instructions that, when executed by the one or more processing resources, cause the one or more processing resources to:
receive a definition of goals for rightsizing and consolidating one or more server nodes of a server system;
receive a specification of a trigger for optimization of the server system;
find one or more sets of application runtime configurations for the server system;
perform a trend analysis on a first set of the one or more sets of application runtime configurations;
predict performance with consolidation of the one or more server nodes based at least in part on the trend analysis;
confirm that the predicted performance matches the goals to verify that the first set satisfies the goals; and
in response to the predicted performance matching the goals, implement the first set of the one or more sets of application runtime configurations in the server system.

19. The system of claim 18, wherein finding the one or more sets of application runtime configurations comprises using a digital twin to simulate one or more metrics corresponding to the goals.

20. The system of claim 18, wherein the instructions are configured to cause the one or more processing resources to:
predict performance with a data center optimization change for the first set; and
in response to the predicted performance matching the goals, implement the data center optimization.
